(19) United States
(12) Patent Application Publication
(10) Pub. No.: US 2001/0037973 A1
(43) Pub. Date: Nov. 8, 2001

(54) Integral Panel Filter Assembly

(76) Inventors: Samuel Rivera, Clarksville, TN (US); Simon D. Ladd, Hopkinsville, KY (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/840,850

(22) Filed: Apr. 24, 2001

Related U.S. Application Data
(60) Provisional application No. 60/199,536, filed on Apr. 25, 2000.

(51) Int. Cl. B01D 29/03

(52) U.S. Cl. 210/495; 210/496

(57) ABSTRACT

A panel filter assembly is provided having an frame integral with a layer of filter media. The frame comprises a peripheral member disposed proximate the perimeter of the sheet of the filter media. The peripheral member is formed of a hard or rigid plastic material and comprises an upstanding portion extending away from a first side of the sheet and a portion penetrating through pores in the sheet to an opposite side of the sheet.

### CROSS REFERENCE TO RELATED APPLICATIONS

Applicants claim the benefit under 35 U.S.C. §119(e) of U.S. Provisional Application No. 60/199,536, filed Apr. 25, 2000, the disclosure of which is incorporated by reference herein.

### STATEMENT REGARDING FEDERALLY SPONSORED RESEARCH OR DEVELOPMENT

N/A

### BACKGROUND OF THE INVENTION

Certain HVAC applications, such as air handling applications, air conditioning units, or paint spraying booths, use removable panel filter assemblies. In a known type of panel filter assembly, illustrated in FIG. 1, a filter media 12 is supported on a metal frame 14. Two layers of filter media are used, one on each side of the frame. The metal frame typically comprises an outer frame 16 of metal rods of narrow cross section welded into a square or rectangular configuration, as required by the particular unit. Additional cross members 18 are generally welded to the outer frame for strengthening or bracing. The layers of filter media cover the frame and extend beyond the perimeter of the frame. The two layers are bonded together by, for example, thermal bonding or radio frequency welding, along bond lines 20 on the outside of the outer frame 16 and at selected lengths 22 along the internal cross members 18 to capture the frame 14 between the two layers of media, thereby retaining the media in place on the frame. The second layer of media is not needed for filtering, so it is usually thinner than the first layer. The free edges 24 of the media are used to provide a seal against air leaks between the filter and the holding frame.

This type of panel filter assembly has several disadvantages. The second layer of filter media is extraneous to the filtering operation. The metal frame cannot be readily disposed of by incineration or grinding.

### SUMMARY OF THE INVENTION

The invention relates to a panel filter assembly that eliminates the extraneous layer of filter media, leading to better filtering performance. After use, the panel filter can be incinerated or ground into small pieces, providing alternative disposal options that may be desirable in some circumstances.

More particularly, the panel filter assembly includes a layer of filter media comprising a porous sheet, typically of a nonwoven polymer. A frame comprising a peripheral member is disposed proximate the perimeter of the sheet of the filter media and penetrates through pores in the sheet to form an integral structure, inseparable except upon disposal and consequent destruction of the assembly. The frame may also include crosspieces for strengthening. The frame is preferably formed of a plastic material that is injectable into a mold as a liquid and the becomes hard or rigid upon curing. The frame also preferably has a tapered cross-section for easier removal from the mold. The filter media may include an edge or border outside the peripheral member of a sufficient size to provide a seal against air leakage between the filter and an associated holding frame.

### DESCRIPTION OF THE DRAWINGS

The invention will be more fully understood from the following detailed description taken in conjunction with the accompanying drawings in which:

FIG. 1 is a plan view of a prior art panel filter assembly;

FIG. 2 is a plan view of a panel filter assembly according to the present invention; and

FIG. 3 is a cross-sectional view of the panel filter assembly taken along line A-A of FIG. 2.

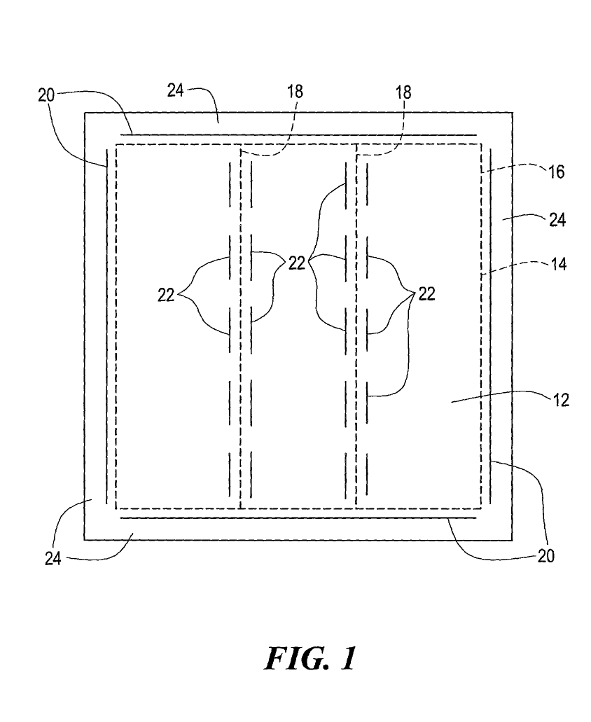

### DETAILED DESCRIPTION OF THE INVENTION

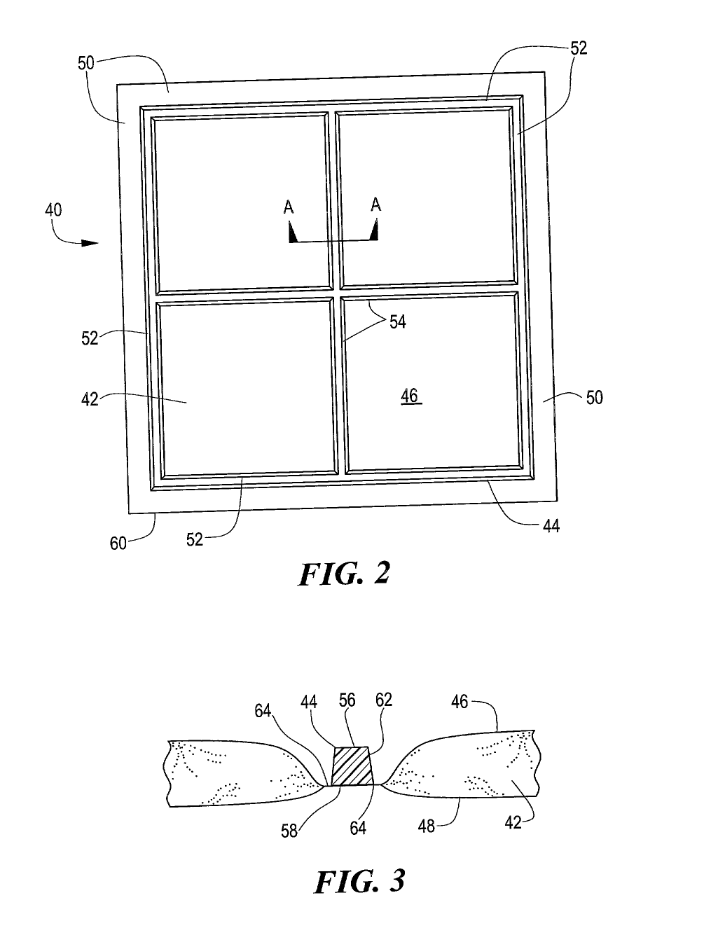

A panel filter assembly 40 according to the present invention is illustrated in FIGS. 2 and 3. The filter comprises a single layer of a filter media 42 to which a plastic frame 44 is integrally attached by penetrating through the pores of the filter media. Multiple layers of media may be used if desired to mix properties of different materials, as required by the application.

The filter media 42 may be any suitable filter media, as would be known in the art. Typically, nonwoven polymer fibers are used to form sheets of filter media. The sheet, which is cut to the appropriate size and shape for the desired application, has a first side or surface 46, a second or opposite side or surface 48, and a perimeter 60. The sheet of filter media is placed into a mold or other suitable support surface having channels for forming the frame.

The frame 44 comprises a peripheral member 52 disposed in a continuous or closed loop proximate the perimeter of the sheet of filter media. The frame 44 is formed of any suitable plastic material, such as a polyurethane that is hard or rigid upon curing. The plastic material in liquid form is injection molded or cast into the channels of the mold and adjacent the first side or surface 46 of the filter media 42. The channel is configured to provide an upstanding portion 62 extending away from the first side. The plastic material also penetrates through the filter media to the opposite side or surface 48. The plastic material is allowed to cure and harden, thereby affixing the frame to the filter media by virtue of the interpenetration of the frame through the pores of the filter media and forming an integral, inseparable structure. The filter media is typically squeezed or compressed at the frame with a small weld impression 64 along both sides of the frame. Preferably, the weld impression is no greater than ⅛ inch wide.

Depending on the application, an edge or border 50 of filter media may be left outside the peripheral member 52 of the frame 44 of a sufficient size to provide a seal against air leakage between the filter and an associated holding frame (not shown). Alternatively, the peripheral member may be disposed as close to the perimeter 60 as practical.

The frame 44 may be constructed in any suitable configuration, depending on the application. As shown, the peripheral member 52 is in the form of an outer rectangle or square, and the frame also includes two orthogonal strengthening crosspieces 54. The frame has a tapered shape in cross-section, best illustrated in FIG. 3, with the face 56 of the upstanding portion 62 having a smaller width dimension (for example, 5/16 inch in width on a ⅜ inch deep upstanding portion) than the face 58 that penetrates through the other side of the media (for example, ⅜ inch in width). The tapered shape makes the frame easier to remove from the mold.

If multiple adjacent parallel layers of filter media are desired for a particular filtering application, it will be appreciated that the frame penetrates through all such layers to form an integral, inseparable structure.

The invention is not to be limited by what has been particularly shown and described, except as indicated by the appended claims.

What is claimed is:

1. A panel filter assembly comprising:
a layer of filter media comprising a porous sheet comprising a first side and a second side and a perimeter; and
a frame comprising a peripheral member disposed proximate the perimeter of the sheet of the filter media, the peripheral member formed of a hard or rigid plastic material and comprising an upstanding portion extending away from the first side of the sheet and a portion penetrating through pores in the sheet to the second side of the sheet.

2. The panel filter assembly of claim 1, wherein the filter media comprises a nonwoven polymer.

3. The panel filter assembly of claim 1, wherein the filter media has a rectangular or square shape.

4. The panel filter assembly of claim 1, wherein the filter media includes a border of filter media outside the peripheral member.

5. The panel filter assembly of claim 1, further comprising a further layer of filter media comprising a further porous sheet parallel to the layer of filter media, the portion of the peripheral member penetrating through pores in the further porous sheet.

6. The panel filter assembly of claim 1, wherein the plastic material comprises a polyurethane.

7. The panel filter assembly of claim 1, wherein the plastic material comprises a cured material that is injectable in liquid form prior to curing.

8. The panel filter assembly of claim 1, wherein the frame comprises a rectangular or square configuration.

9. The panel filter assembly of claim 1, wherein the frame further includes a crosspiece extending through a central portion of the filter media from a first section of the peripheral member to a second section of the peripheral member.

10. The panel filter assembly of claim 9, wherein the frame further comprises a further crosspiece extending through the central portion of the filter media orthogonal to the crosspiece.

11. The panel filter assembly of claim 1, wherein the frame has a tapered shape in cross-section.
